(19) United States
(12) Patent Application Publication
(10) Pub. No.: US 2014/0136870 A1
(43) Pub. Date: May 15, 2014

(54) TRACKING MEMORY BANK UTILITY AND COST FOR INTELLIGENT SHUTDOWN DECISIONS

(71) Applicant: ADVANCED MICRO DEVICES, INC., Sunnyvale, CA (US)

(72) Inventors: Mauricio BRETERNITZ, Austin, TX (US); James M. O'CONNOR, Austin, TX (US); Gabriel H. LOH, Bellevue, WA (US); Yasuko ECKERT, Kirkland, WA (US); Mithuna THOTTETHODI, Bellevue, WA (US); Srilatha MANNE, Portland, OR (US); Bradford M. BECKMANN, Redmond, WA (US)

(73) Assignee: Advanced Micro Devices, Inc., Sunnyvale, CA (US)

(21) Appl. No.: 13/676,863

(22) Filed: Nov. 14, 2012

(51) Int. Cl. G06F 1/32

(52) U.S. Cl. CPC G06F 1/3203
USPC 713/323

(57) ABSTRACT

A device receives an indication that a memory bank is to be powered down, and determines, based on receiving the indication, shutdown scores corresponding to powered up memory banks. Each shutdown score is based on a shutdown metric associated with powering down a powered up memory bank. The device may power down a selected memory bank based on the shutdown scores.

### BACKGROUND

A central processing unit stores information in a cache to reduce the average time to access the information. The cache is typically a smaller, faster memory than main memory, such as random access memory. The cache often stores a copy of information stored in the most frequently used main memory locations. The cache may be located closer to the central processing unit than main memory, thus decreasing the amount of time and/or energy needed to access information stored in the cache.

### SUMMARY OF EMBODIMENTS OF AN INVENTION

According to an embodiment described herein, a device receives an indication that a memory bank is to be powered down. The device determines, based on receiving the indication, shutdown scores corresponding to powered up memory banks. Each shutdown score is based on a shutdown metric associated with powering down a powered up memory bank. The device may power down a selected memory bank based on the shutdown scores.

### BRIEF DESCRIPTION OF THE DRAWINGS

FIG. 1 is a diagram of an overview of an example embodiment described herein;

FIG. 2 is a diagram of example components of a device in which embodiments described herein may be implemented, according to some embodiments;

FIG. 3 is a diagram of example components that may correspond to one or more components illustrated in FIG. 2, according to some embodiments;

FIG. 4 is a diagram of an example process for powering down a memory bank, according to some embodiments; and

FIGS. 5-8 are diagrams of example embodiments relating to the example process illustrated in FIG. 4.

### DETAILED DESCRIPTION OF EXEMPLARY EMBODIMENTS

The following detailed description of example embodiments refers to the accompanying drawings. The same reference numbers in different drawings may identify the same or similar elements.

A processor, such as a central processing unit (“CPU”), may store information in memory banks, such as memory banks included in a CPU cache. In order to save power, the CPU may power down some of the memory banks. However, powering down a memory bank may reduce performance of a system incorporating the CPU and the memory banks. Embodiments described herein assist a CPU in determining one or more memory banks to power down based on resulting system performance and power consumption.

As used herein, the term “powering down” a memory bank (and other similar terms, such as “power down,” “powered down,” “shutting down,” “shut down,” “shutdown,” etc.) refers to adjusting a power characteristic of a memory bank so that the memory bank may not be utilized to store information. For example, powering down a memory bank may refer to terminating a supply of power (e.g., a current, a voltage, etc.) to the memory bank and/or turning the memory bank off. As another example, powering down a memory bank may refer to transitioning the memory bank from a first power consumption state (e.g., on, awake, ready, etc.) to a second power consumption state (e.g., off, asleep, standby, hibernation, etc.), where the amount of power consumed by the memory bank in the first power consumption state is greater than the amount of power consumed by the memory bank in the second power consumption state.

As used herein, the term “powering up” a memory bank (and other similar terms, such as “power up,” “powered up,” etc.) refers to adjusting a power characteristic of a memory bank so that the memory bank may be utilized to store information. For example, powering up a memory bank may refer to supplying power (e.g., a current, a voltage, etc.) to the memory bank and/or turning the memory bank on. As another example, powering up a memory bank may refer to transitioning the memory bank from a second power consumption state (e.g., off, asleep, standby, hibernation, etc.) to a first power consumption state (e.g., on, awake, ready, etc.), where the amount of power consumed by the memory bank in the first power consumption state is greater than the amount of power consumed by the memory bank in the second power consumption state.

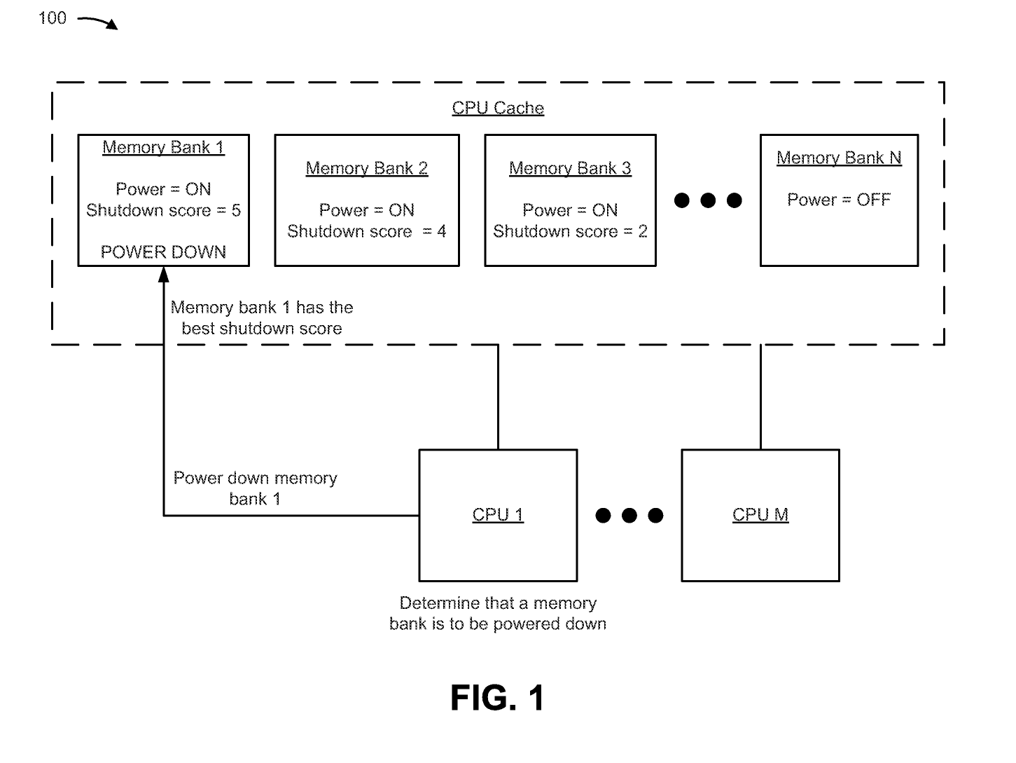

FIG. 1 is a diagram of an overview of an example embodiment 100 described herein. As illustrated in FIG. 1, embodiment 100 includes one or more CPUs (e.g., M CPUs, where M>1) connected to a CPU cache that includes N memory banks (N>1). In some embodiments, the CPU cache may be integrated into (and a part of) the CPU. Additionally, or alternatively, the CPU cache may be shared by multiple CPUs. Processors other than a CPU may also perform embodiments described herein. Such processors may include, for example, a graphics processing unit (GPU), an accelerated processing unit (APU), an application processor, an application specific integrated circuit (ASIC), a digital signal processor (DSP), or the like.

As shown by embodiment 100, the CPU determines that a memory bank is to be powered down, and calculates a shutdown score for one or more powered up memory banks. In example embodiment 100, memory banks 1, 2, and 3 are powered up (“Power=ON”), and memory bank N is powered down (“Power=OFF”). Memory bank 1 has a shutdown score of five (5), memory bank 2 has a shutdown score of four (4), and memory bank 3 has a shutdown score of two (2).

The shutdown score for a memory bank indicates a power savings and/or a performance reduction resulting from powering down the memory bank. In example embodiment 100, powering down memory bank 1 causes a greater power savings and/or a smaller performance reduction than powering down memory bank 2, and powering down memory bank 2 causes a greater power savings and/or a smaller performance reduction than powering down memory bank 3. These characteristics of the memory banks are reflected in the shutdown scores associated with memory banks 1, 2, and 3.

As further shown in embodiment 100, the CPU determines that memory bank 1 has the best shutdown score of all memory banks that are available to be powered down, and powers down memory bank 1. In this way, the CPU can power down the memory bank that provides the best power savings and/or the least performance reduction when compared to powering down other memory banks.

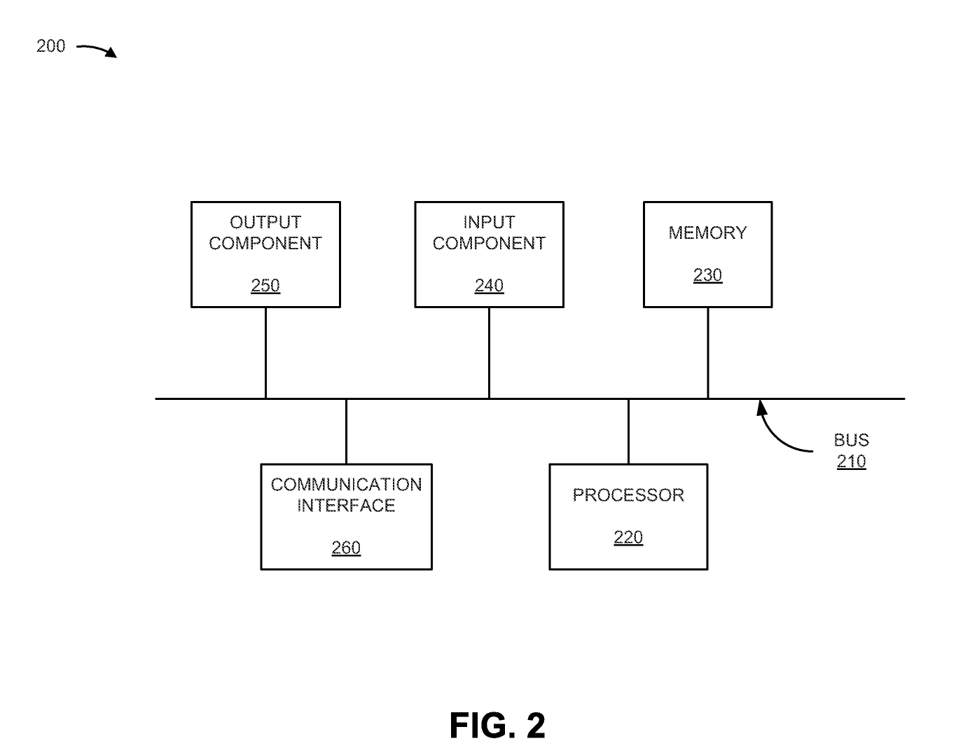

FIG. 2 is a diagram of example components of a device 200 in which embodiments described herein may be implemented. As illustrated in FIG. 2, device 200 includes a bus 210, a processor 220, a memory 230, an input component 240, an output component 250, and a communication interface 260.

Bus 210 includes a path that permits communication among the components of device 200. Processor 220 includes a processing device (e.g., a CPU, a GPU, an APU, an ASIC, a DSP, etc.) that interprets and/or executes instructions. In some embodiments, processor 220 includes one or more processor cores. Additionally, or alternatively, processor 220 may include a combination of processing units.

Memory 230 includes a CPU cache, a scratchpad memory, and/or any type of multi-banked memory that stores information and/or instructions for use by processor 220. Additionally, or alternatively, memory 230 may include random access memory (“RAM”), a read only memory (“ROM”), and/or any type of dynamic or static storage device (e.g., a flash, magnetic, or optical memory) that stores information and/or instructions for use by processor 220.

Input component 240 includes a component that permits a user to input information to device 200 (e.g., a keyboard, a keypad, a mouse, a button, a switch, etc.). Output component 250 includes a component that outputs information from device 200 (e.g., a display, a speaker, one or more light-emitting diodes (“LEDs”), etc.).

Communication interface 260 includes a transceiver-like component, such as a transceiver and/or a separate receiver and transmitter, that enables device 200 to communicate with other devices and/or systems, such as via a wired connection, a wireless connection, or a combination of wired and wireless connections. For example, communication interface 260 may include an Ethernet interface, an optical interface, a coaxial interface, an infrared interface, a radio frequency (“RF”) interface, a universal serial bus (“USB”) interface, or the like.

Device 200 performs various operations described herein, in some embodiments. Device 200 may perform these operations in response to processor 220 executing software instructions included in a computer-readable medium, such as memory 230. A computer-readable medium may be defined as a non-transitory memory device. A memory device includes space within a single storage device or space spread across multiple storage devices.

In some embodiments, software instructions are read into memory 230 from another computer-readable medium or from another device via communication interface 260. When executed, software instructions stored in memory 230 cause processor 220 to perform one or more processes that are described herein. Additionally, or alternatively, hardwired circuitry may be used in place of or in combination with software instructions to perform one or more processes described herein. Thus, embodiments described herein are not limited to any specific combination of hardware circuitry and software.

The number of components illustrated in FIG. 2 is provided for explanatory purposes. In practice, device 200 may include additional components, fewer components, different components, or differently arranged components than those illustrated in FIG. 2.

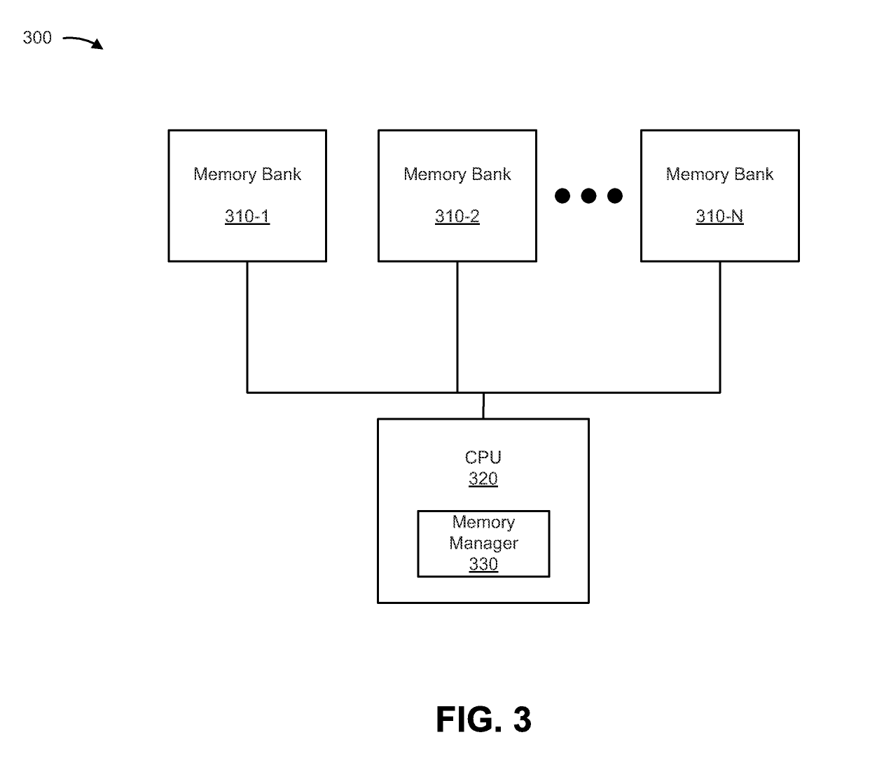

FIG. 3 is a diagram of example components 300 that correspond to processor 220 and/or memory 230 of FIG. 2, in some embodiments. As illustrated in FIG. 3, components 300 include memory banks 310-1 through 310-N (N>1) (hereinafter referred to collectively as “memory banks 310,” and individually as “memory bank 310”), a CPU 320, and a memory manager 330.

Memory bank 310 includes a storage unit and/or a storage block in which information may be stored. In some embodiments, memory bank 310 corresponds to and/or is incorporated into memory 230. In some embodiments, memory bank 310 is a logical storage unit of a cache and/or a scratchpad memory.

As used herein, the term “block” or “memory block” refers to a sub-division, a section, or a portion of memory bank 310, such as a section that can be read from and/or written to individually. For example, a memory block may refer to a cache line of a cache, a fixed-size block of a scratchpad or other multi-banked memory, etc.

CPU 320 includes a processor, a microprocessor, and/or any processing device and/or processing logic that interprets and executes instructions. In some embodiments, CPU 320 corresponds to processor 220. In some embodiments, CPU 320 and/or another component (e.g., memory manager 330) divides memory (e.g., memory 230, a CPU cache, a scratchpad memory, etc.) into a set of memory banks 310. In some embodiments, CPU 320 includes multiple CPUs, GPUs, APUs, processors, and/or processor cores that share memory banks 310.

Memory manager 330 performs operations associated with powering down a memory bank 310. In some embodiments, memory manager 330 determines that a memory bank 310 is to be powered down, and selects one or more memory banks 310 to power down based on shutdown scores associated with memory banks 310. Additionally, or alternatively, memory manager 330 may transfer information stored in the selected memory bank 310 to another memory bank 310, and may power down the selected memory bank 310. While illustrated as being integrated into (and a part of) CPU 320, memory manager 330 is separate from CPU 320 in some embodiments.

The number of components 300 illustrated in FIG. 3 is provided for explanatory purposes. In practice, components 300 may include additional components, fewer components, different components, or differently arranged components than those illustrated in FIG. 3.

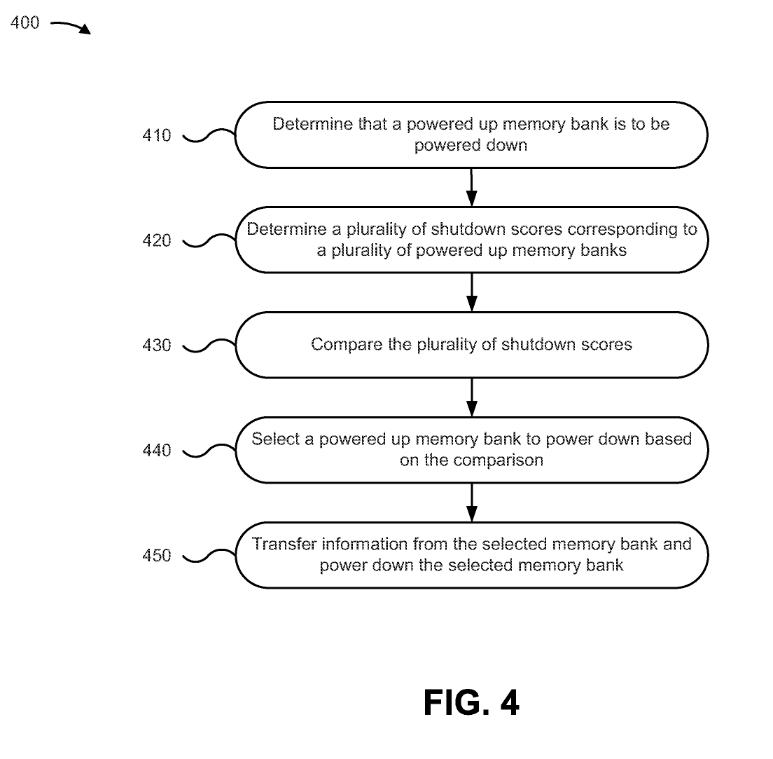

FIG. 4 is a diagram of an example process 400 for powering down a memory bank, according to some embodiments. In some embodiments, one or more process blocks of FIG. 4 are performed by one or more components of CPU 320 and/or memory manager 330. Additionally, or alternatively, one or more process blocks of FIG. 4 may be performed by one or more components of another device or a collection of devices including or excluding CPU 320 and/or memory manager 330.

As shown in FIG. 4, process 400 includes determining that a powered up memory bank is to be powered down (block 410). In some embodiments, memory manager 330 receives an indication that a memory bank 310 is to be powered down. The indication may be based on an indication that a memory footprint is low (e.g., below a threshold or satisfying a threshold). A memory footprint refers to an amount of memory, included in memory banks 310, being used or referenced by a system that utilizes memory banks 310. Additionally, or alternatively, the indication may be based on a system, utilizing memory banks 310, entering a particular power state. For example, a system, such as a laptop, may enter a low power state when it is operating on battery power. In some embodiments, the indication is based on a voltage level at which CPU 320 and/or a system that utilizes memory banks 310 operates.

As further shown in FIG. 4, process 400 includes determining a plurality of shutdown scores corresponding to a plurality of powered up memory banks (block 420), comparing the plurality of shutdown scores (block 430), and selecting a powered up memory bank to power down based on the comparison (block 440). In some embodiments, memory manager 330 determines a shutdown score for each powered up memory bank 310 that is available to be powered down. Memory manager 330 determines which memory bank 310 has the best shutdown score (e.g., the highest score, the lowest score, the score closest to a target score, etc.), and powers down the memory bank 310 with the best shutdown score.

In some embodiments, the shutdown score is based on a power savings resulting from powering down memory bank 310. For example, memory manager 330 may power down the memory bank 310 that results in the best (e.g., greatest) power savings for a system utilizing memory bank 310. In other embodiments, the shutdown score is based on a performance reduction resulting from powering down memory bank 310. For example, memory manager 330 may power down the memory bank 310 that results in the best (e.g., least) performance reduction for a system utilizing memory bank 310. To determine the performance reduction, memory manager 330 may calculate a difference between a value of a shutdown metric measured before powering down the selected memory bank, and an estimated value of the shutdown metric after powering down the selected memory bank.

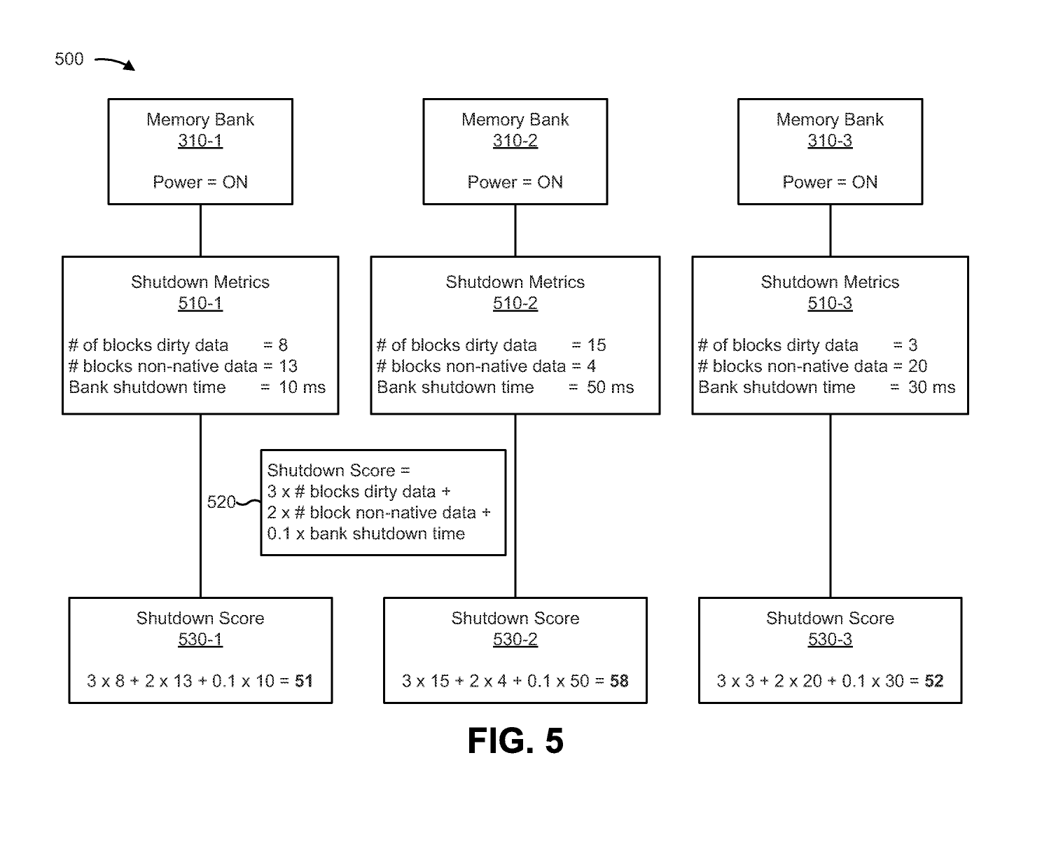

Memory manager 330 may measure power savings and/or performance reduction using one or more shutdown metrics, which may be combined to calculate a shutdown score, as described in more detail in connection with FIG. 5. In some embodiments, the shutdown score is based on a single shutdown metric. In other embodiments, the shutdown score is based on a combination (e.g., a weighted combination) of multiple shutdown metrics.

As further shown in FIG. 4, process 400 includes transferring information from the selected memory bank and powering down the selected memory bank (block 450). In some embodiments, memory manager 330 transfers information from the selected memory bank 310 to one or more other memory banks 310. After the information has been transferred, memory manager 330 shuts down the selected memory bank 310. Alternatively, memory manager 330 may shut down the selected memory bank 310 without transferring the information.

While a series of blocks has been described with regard to FIG. 4, the order of the blocks may be modified in some embodiments. Additionally, or alternatively, non-dependent blocks may be performed in parallel.

FIG. 5 is a diagram of an example embodiment 500 relating to process 400, illustrated in FIG. 4. FIG. 5 illustrates calculating shutdown scores for memory banks 310.

As illustrated in FIG. 5, memory manager 330 tracks shutdown metrics 510 for memory banks 310, and uses a shutdown score equation 520 to calculate a shutdown score 530 for each memory bank 310. As further illustrated, memory manager 330 tracks shutdown metrics 510-1 for memory bank 310-1, tracks shutdown metrics 510-2 for memory bank 310-2, and tracks shutdown metrics 510-3 for memory bank 310-3. Each of memory banks 310-1, 310-2, and 310-3 are powered up (e.g., “Power=ON”), and memory manager 330 may track shutdown metrics 510 for powered up memory banks 310 in order to determine one or more memory banks 310 to power down.

In some embodiments, shutdown metric 510 includes a quantity of blocks in memory bank 310 that store dirty data. Dirty data refers to information, stored in memory bank 310, that is to be written to main memory. For example, dirty data may include information that has been written to memory bank 310, but has not yet been written to main memory. Dirty data may represent the most up-to-date copy of the information. If the dirty data is evicted from memory bank 310, it must first be written to main memory to ensure that the most up-to-date copy of the information is stored.

Shutdown metric 510 includes a quantity of blocks in memory bank 310 that store non-native data, in some embodiments. Non-native data may refer to information, stored in memory bank 310 of CPU 320, that is read by and/or written by another CPU other than CPU 320. Additionally, or alternatively, non-native data may refer to information, stored in memory bank 310 of a particular processor core, that is read by and/or written by another processor core other than the particular processor core. An example of a block that stores non-native data is a block, in a non-uniform memory access (NUMA) architecture, with a home node in a different socket than the block. As another example, a processor reads from and/or writes to a memory bank 310, but when that memory bank 310 is powered down, the processor reads from and/or writes to a different memory bank 310 (or multiple different memory banks 310). The information read from and/or written to the different memory bank 310 is non-native data. Additionally, or alternatively, shutdown metric 510 may include a quantity of memory blocks in memory bank 310 that contain native information (e.g., native to a memory bank 310 that stores the information).

In some embodiments, shutdown metric 510 includes a quantity of blocks in memory bank 310 that store non-native dirty data. Non-native dirty data includes information that is both dirty and non-native.

Shutdown metric 510 includes an amount of time required to power down memory bank 310, in some embodiments.

In other embodiments, shutdown metric 510 includes a quantity of blocks in memory bank 310 that store dirty data predicted to be written to main memory. For example, memory manager 330 may use a prediction algorithm to estimate whether dirty data, stored in a block, is likely to be written to main memory, or whether the dirty data is likely to be evicted (e.g., removed and/or deleted from memory bank 310).

In still other embodiments, shutdown metric 510 includes a quantity of blocks in memory bank 310 that have not been used (e.g., read from and/or written to) for a particular time period. The particular time period includes, in some embodiments, a time period up to and including the time at which shutdown metric 510 is measured. For example, shutdown metric 510 may include a quantity of blocks that have not been used in the most recent ten seconds (e.g., the ten seconds leading up to the time that shutdown metric 510 is measured).

Shutdown metric 510 includes, in some embodiments, an amount of time that a block in memory bank 310 has been unused (e.g., not read from and/or written to). For example, shutdown metric 510 may include a longest amount of time that a block in memory bank 310 has been unused (when compared to other blocks in memory bank 310), up to the time at which shutdown metric 510 is measured. In some embodiments, shutdown metric 510 includes a shortest amount of time that a block in memory bank 310 has been unused (when compared to other blocks in memory bank 310), up to the time at which shutdown metric 510 is measured. Additionally, or alternatively, shutdown metric 510 may include an average amount of time that each block in memory bank 310 has been unused, up to the time at which shutdown metric 510 is measured.

In some embodiments, shutdown metric 510 includes a quantity of blocks and/or an amount of information in memory bank 310 predicted to be unused in a future time period (e.g., a time period after shutdown metric 510 is measured). For example, information stored in a block is predicted to be unused when the information is referenced (e.g., read and/or written) by a process, program, and/or thread that has been terminated.

Shutdown metric 510 includes, in some embodiments, a quantity of error correction code (ECC) errors reported by a block of memory bank 310, and/or a quantity of ECC errors reported by memory bank 310.

In some embodiments, shutdown metric 510 includes a quantity of blocks in memory bank 310 that store shared information. Shared information refers to information that is read by and/or written by more than one CPU 320 and/or more than one processor core. In alternative embodiments, the shutdown metric includes a quantity of memory blocks in memory bank 310 that contain non-shared information. Non-shared information refers to information that is read by and/or written by only one CPU 320 and/or only one processor core.

In other embodiments, shutdown metric 510 includes a quantity of blocks in memory bank 310 that store exclusive information. Exclusive information refers to information that is stored by a single block and/or a single memory bank 310. In alternative embodiments, shutdown metric 510 includes a quantity of blocks in memory bank 310 that store non-exclusive information. Non-exclusive information refers to information that is stored by multiple blocks and/or multiple memory banks 310.

In still other embodiments, shutdown metric 510 includes a quantity of blocks in memory bank 310 that contain an instruction and/or read-only information. Alternatively, the shutdown metric includes a quantity of blocks in memory bank 310 that contain a non-instruction and/or non-read-only information (e.g., read/write information).

Shutdown metric 510 includes, in some embodiments, a quantity of blocks, in memory bank 310, accessed by CPU requests, APU requests, and/or GPU requests. Alternatively, shutdown metric 510 includes a quantity of blocks, in memory bank 310, accessed by non-CPU requests, non-APU requests, and/or non-GPU requests.

Shutdown metric 510 includes an amount of energy and/or power consumed by memory bank 310, in some embodiments. The amount of energy and/or power consumed may include an amount of leakage energy and/or an amount of dynamic energy. Leakage energy refers to energy and/or power, consumed by memory bank 310, that does not contribute to the functions of memory bank 310. Dynamic energy refers to energy and/or power, consumed by memory bank 310, when memory bank 310 is performing specific functions. In some embodiments, dynamic energy is determined on a per access basis. For example, dynamic energy may be calculated as an amount of energy consumed by memory bank 310 each time memory bank 310 is accessed (e.g., read from or written to).

In some embodiments, shutdown metric 510 includes an amount of voltage (e.g., a minimum amount of voltage) required to operate memory bank 310.

In other embodiments, shutdown metric 510 includes an access latency of memory bank 310. Access latency refers to an amount of time between a request to access information stored by memory bank 310 and a response to the request (e.g., access being completed and/or the request being processed).

In still other embodiments, shutdown metric 510 includes a distance between memory bank 310 and a CPU 320 that accesses memory bank 310. Additionally, or alternatively, shutdown metric 510 includes a distance between memory bank 310 and a component to which information, stored by memory bank 310, will be transferred upon powering down memory bank 310. The distance may refer to a distance of a wire and/or a circuit that connects memory bank 310 to the component. Alternatively, the distance may refer to an average distance between one or more memory banks 310 and one or more components. In some embodiments, the distance includes a distance to memory bank 310 in a non-uniform cache architecture.

Shutdown metric 510 includes, in some embodiments, a quantity of accesses to memory bank 310, which may refer to a quantity of times that CPU 320 accesses and/or attempts to access memory bank 310. The quantity of accesses may include a quantity of times that CPU 320 reads and/or attempts to read information from memory bank 310, and/or may include a quantity of times that CPU 320 writes and/or attempts to write information to memory bank 310. For example, the quantity of accesses may include a quantity of accesses to memory bank 310 in a non-volatile RAM cache.

Memory manager 330 may compare one or more shutdown metrics 510, for a memory bank 310, to a threshold, in order to determine a memory bank 310 to power down. Additionally, or alternatively, memory manager 330 may compare shutdown metrics 510 measured for different memory banks 310 in order to determine a memory bank 310 to power down.

In some embodiments, memory manager 330 determines to power down a memory bank 310 having a low value for shutdown metric 510 (e.g., lower than a threshold and/or lower than a shutdown metric 510 measured for other memory banks 310). Alternatively, memory manager 330 may determine to power down a memory bank 310 having a high value for shutdown metric 510 (e.g., higher than a threshold and/or higher than a shutdown metric 510 measured for other memory banks 310). Alternatively, memory manager 330 may determine to power down a memory bank 310 having a value for shutdown metric 510 that is closest to a target value (e.g., within a range of the target value and/or closet to the target value than a shutdown metric 510 measured for other memory banks 320).

For example, memory manager 330 may determine to power down memory bank 310 based on memory bank 310 having a low quantity of blocks that store dirty data, a high quantity of blocks that contain non-dirty data, a low quantity of blocks that contain non-native data, a high quantity of blocks that contain native data, a low quantity of blocks that contain non-native dirty data, a high quantity of blocks that contain native non-dirty data, a low amount of time required to power down, a low quantity of blocks that store dirty data predicted to be written to main memory, a high quantity of unused blocks (for a particular time period), a low quantity of used blocks (for a particular time period), a high amount of time that a block has been unused, a low amount of time that a block has been used, a high quantity of blocks and/or information predicted to be unused, a low quantity of blocks and/or information predicted to be used, a high quantity of ECC errors, a low quantity of ECC errors, a low quantity of blocks that store shared information, a high quantity of blocks that store non-shared information, a low quantity of blocks that store exclusive information, a high quantity of blocks that store non-exclusive information, a low quantity of blocks that contain an instruction and/or read-only information, a high quantity of blocks that contain a non-instruction and/or non-read-only information, a low quantity of blocks accessed by CPU requests, a high quantity of blocks accessed by non-CPU requests, a high amount of energy and/or power consumed, a high amount of voltage required to operate, a high access latency, a large distance to CPU 320 and/or other components, and/or a high quantity of accesses.

In some embodiments, memory manager 330 uses a combination of shutdown metrics 510 to determine a memory bank 310 to power down. For example, memory manager 330 may use shutdown score equation 520 to calculate shutdown score 530 by combining multiple shutdown metrics 510 (e.g., via addition, subtraction, multiplication, division, and/or any other mathematical operation that may be used to combine shutdown metrics 510). In some embodiments, memory manager 330 applies a weight to shutdown metric 510 when calculating shutdown score 530. For example, memory manager 330 may apply a weight to each shutdown metric 510. The weight may be a number (e.g., equal to one, greater than one, less than one) that is combined with shutdown metric 510 using, multiplication, division, or another mathematical operation. The weight applied to one shutdown metric may be the same as or different from the weight applied to another shutdown metric.

Returning to the example shown in FIG. 5, memory manager 330 tracks three shutdown metrics 510 for each powered up memory bank 310. As shown in FIG. 5, shutdown metrics 510 include a quantity of blocks storing dirty data, a quantity of blocks storing non-native data, and a memory bank shutdown time (e.g., measured in microseconds, or any other unit of time).

As illustrated by shutdown metric 510-1, memory bank 310-1 contains 8 blocks with dirty data, contains 13 blocks with non-native data, and requires 10 microseconds to power down. As illustrated by shutdown metric 510-2, memory bank 310-2 contains 15 blocks with dirty data, contains 4 blocks with non-native data, and requires 50 microseconds to power down. As illustrated by shutdown metric 510-3, memory bank 310-3 contains 3 blocks with dirty data, contains 20 blocks with non-native data, and requires 30 microseconds to power down.

As illustrated by shutdown score equation 520, memory manager 330 calculates a shutdown score 530 for each memory bank 310 by applying a weight to each shutdown metric 510 and combining each shutdown metric 510. For example, shutdown score equation 520 includes the following equation:

Shutdown score=(3×quantity of blocks storing dirty data)+(2×quantity of blocks storing non-native data)+(0.1×time required to shutdown memory bank)

This equation is provided for explanatory purposes. In practice, shutdown score 530 may be calculated using any combination of shutdown metrics 510 and/or weights applied to shutdown metrics 510, or any mathematical function (e.g., a linear function, a non-linear function, etc.).

As illustrated by shutdown score 530-1, memory manager 330 calculates a shutdown score 530 for memory bank 310-1 using shutdown score equation 520, as follows:

Shutdown score for memory bank 310-1=(3×8 blocks storing dirty data)+(2×13 blocks storing non-native data)+(0.1×10 microseconds required for shutdown)=51.

As illustrated by shutdown score 530-2, memory manager 330 calculates a shutdown score 530 for memory bank 310-2 using shutdown score equation 520, as follows:

Shutdown score for memory bank 310-2=(3×15 blocks storing dirty data)+(2×4 blocks storing non-native data)+(0.1×50 microseconds required for shutdown)=58.

As illustrated by shutdown score 530-3, memory manager 330 calculates a shutdown score 530 for memory bank 310-3 using shutdown score equation 520, as follows:

Shutdown score for memory bank 310-3=(3×3 blocks storing dirty data)+(2×20 blocks storing non-native data)+(0.1×30 microseconds required for shutdown)=52.

Memory manager 330 uses shutdown scores 530-1, 530-2, and 530-3 to select a memory bank 310 to power down. In some embodiments, memory manager 330 powers down memory bank 310 with the lowest shutdown score 530, when compared to other memory banks 310. Alternatively, memory manager 330 may power down memory bank 310 with the highest shutdown score 530, when compared to other memory banks 310. Alternatively, memory manager 330 may power down memory bank 310 with the shutdown score 530 closest to a target value, when compared to other memory banks 310.

The information shown in FIG. 5, such as shutdown metrics 510, shutdown score equation 520, and shutdown scores 530, is provided for explanatory purposes. In practice, memory manager 330 may use additional information, less information, different information, and/or differently arranged information than illustrated in FIG. 5.

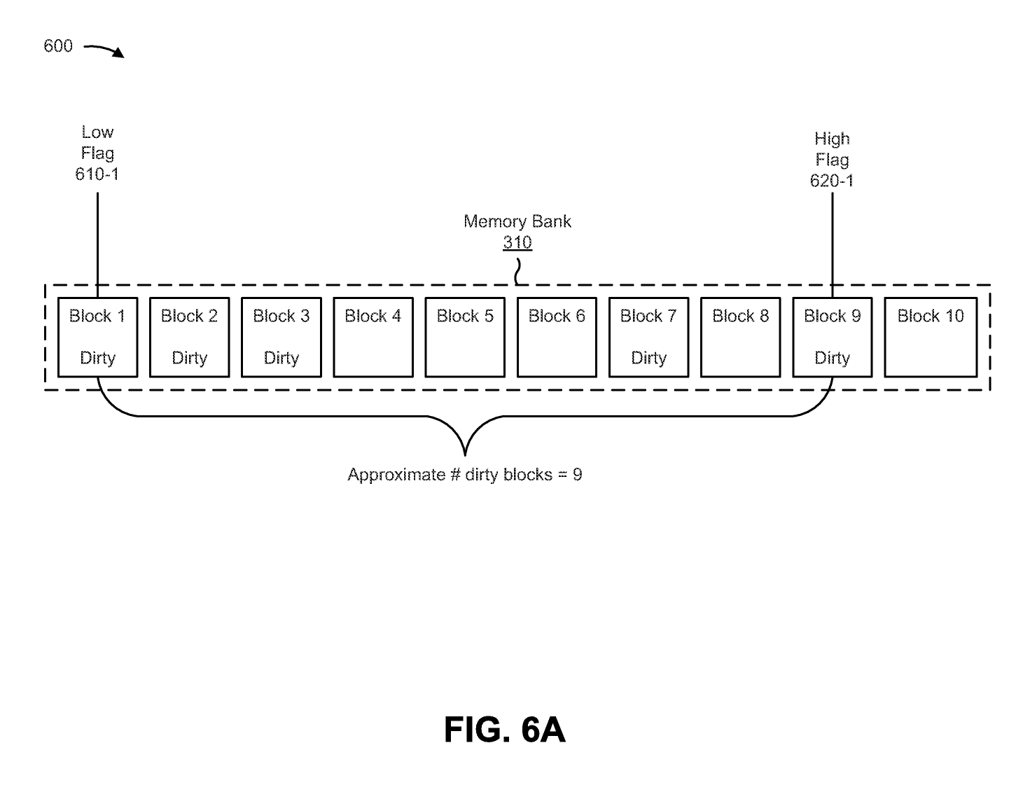

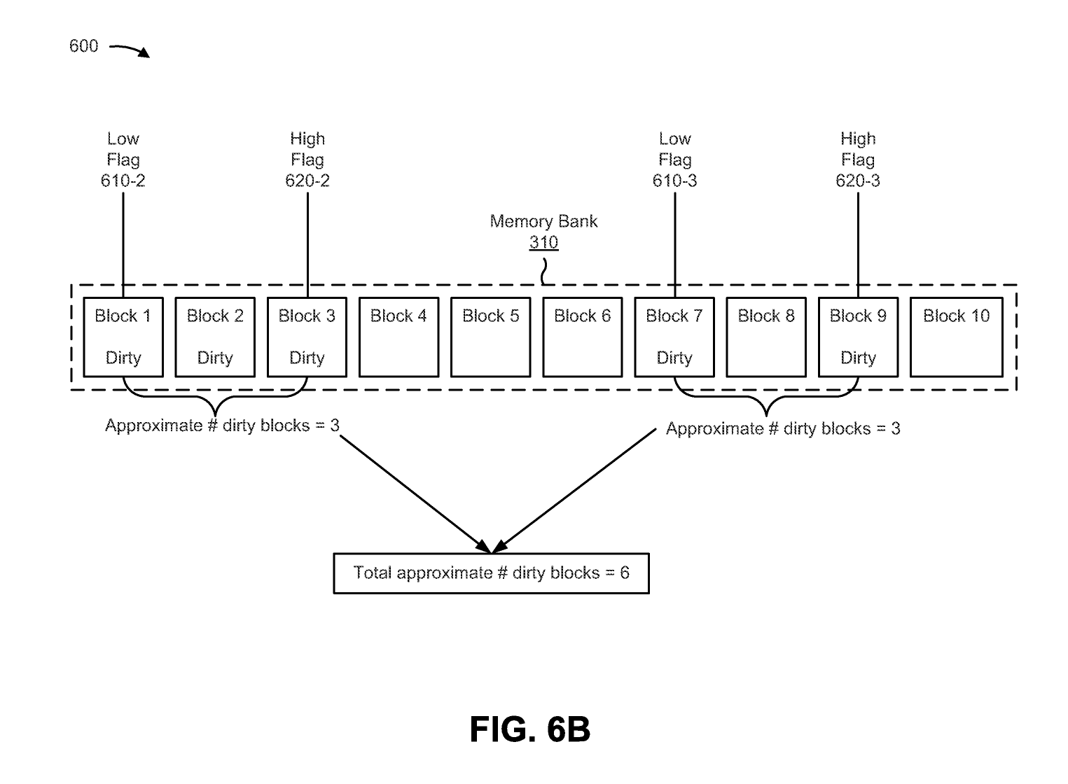

FIGS. 6A and 6B are diagrams of an example embodiment 600 relating to process 400, illustrated in FIG. 4. FIGS. 6A and 6B illustrate a technique for estimating a quantity of blocks in memory bank 310 that meet particular criteria (e.g., a quantity of blocks storing dirty data, non-native data, etc.).

As illustrated in FIG. 6A, memory bank 310 includes multiple blocks (e.g., memory blocks or storage blocks) that store information. In some embodiments, memory manager 330 determines an exact quantity of blocks that meet a particular criteria, such as an exact quantity of blocks storing dirty data, non-native data, etc. Alternatively, memory manager 330 may determine an approximate quantity of blocks that meet the particular criteria.

To determine an approximate quantity of blocks that meet the particular criteria, memory manager 330 numbers and/or identifies a set of contiguous blocks in memory bank 310 from low to high. For example, the blocks may be numbered from 1 to 10, as illustrated in FIG. 6A. Memory manager 330 determines the approximate quantity of blocks using a pair of flags, such as low flag 610-1 and high flag 620-1. Memory manager 330 flags a “low” block (e.g., the lowest numbered block) that meets the particular criteria, as illustrated by low flag 610-1. Memory manager 330 also flags a “high” block (e.g., the highest numbered block) that meets the particular criteria, as illustrated by high flag 620-1.

As illustrated, blocks 1, 2, 3, 7, and 9 store dirty data. Memory manager 330 uses a pair of low/high flags to flag the lowest block storing dirty data (e.g., block 1) and the highest block storing dirty data (e.g., block 9). Memory manager 330 counts the quantity of blocks between the low block and the high block (e.g., including the low block and the high block), to determine the approximate quantity of blocks containing dirty information. For example, memory manager 330 uses the low/high flag pair to estimate that 9 blocks store dirty data (e.g., blocks 1 through 9).

As illustrated in FIG. 6B, memory manager 330 may use multiple pairs of low/high flags to determine an approximate quantity of blocks that meet the particular criteria. For example, memory manager 330 flags block 1 with a first low flag 610-2, and flags block 3 with a first high flag 620-2, as illustrated. Similarly, memory manager 330 flags block 7 with a second low flag 610-3, and flags block 9 with a second high flag 620-3. Memory manager 330 determines the approximate quantity by summing the blocks between blocks 1 and 3 (e.g., inclusive), and between blocks 7 and 9 (e.g., inclusive), to estimate that six blocks store dirty data (e.g., blocks 1 through 3 and 7 through 9).

The information shown in FIGS. 6A and 6B, such as the quantity of blocks and the quantity of low/high flags, is provided for explanatory purposes. In practice, memory manager 330 may use additional information, less information, different information, and/or differently arranged information than illustrated in FIGS. 6A and 6B. For example, in some embodiments, memory manager 330 uses a different quantity of low/high flags than illustrated in FIGS. 6A and 6B.

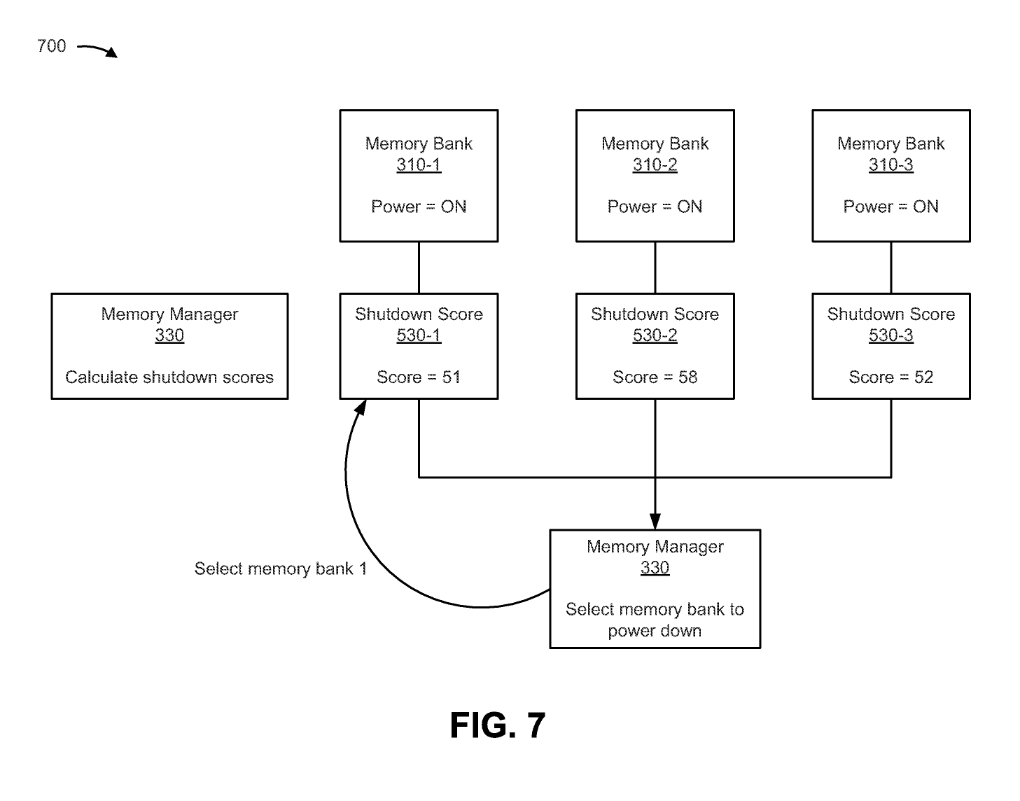

FIG. 7 is a diagram of an example embodiment 700 relating to process 400, illustrated in FIG. 4. FIG. 7 illustrates selecting a powered up memory bank 310 to power down based on comparing shutdown scores for multiple memory banks 310.

As illustrated in FIG. 7, memory manager 330 calculates a shutdown score 530 for a memory bank 310, as discussed herein in connection with FIG. 5. Assume that memory manager 330 calculates a score of 51 for memory bank 310-1, a score of 58 for memory bank 310-2, and a score of 52 for memory bank 310-3, as illustrated.

As further illustrated in FIG. 7, memory manager 330 selects a memory bank 310 to power down based on the shutdown scores. In the example embodiment of FIG. 7, memory manager 330 selects memory bank 310-1, which has the lowest shutdown score when compared to memory banks 310-2 and 310-3.

The information shown in FIG. 7, such as the shutdown scores and the quantity of memory banks 310, is provided for explanatory purposes. In practice, memory manager 330 may use additional information, less information, different information, and/or differently arranged information than illustrated in FIG. 7.

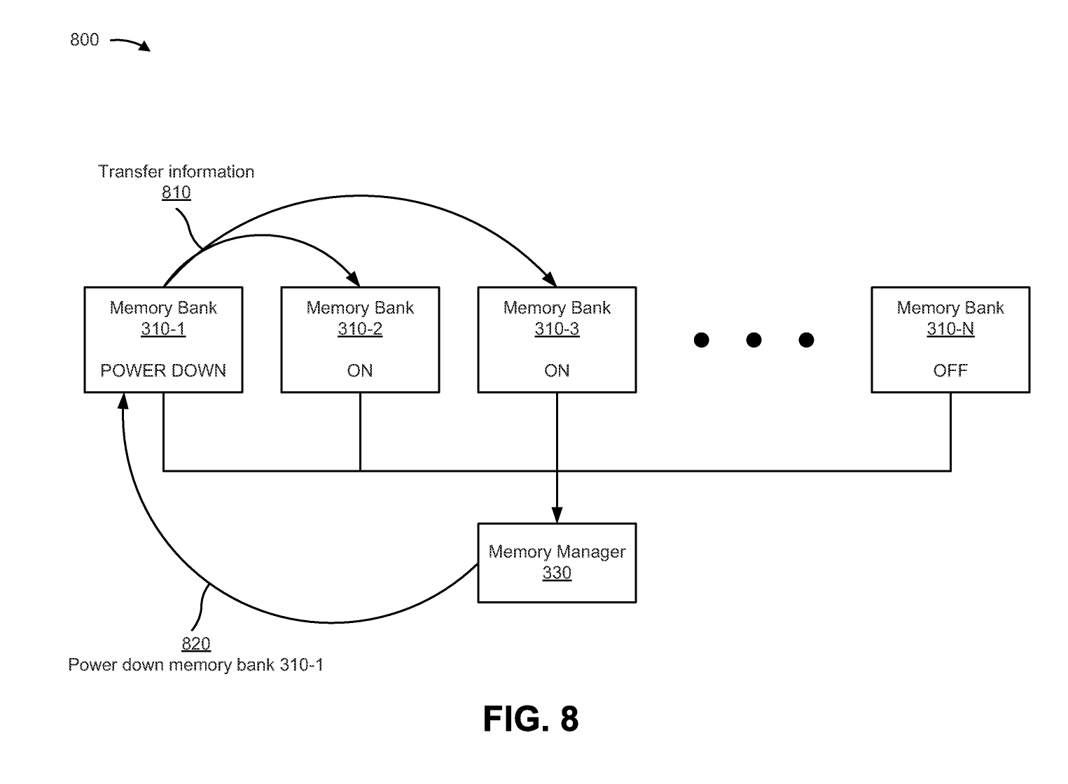

FIG. 8 is a diagram of an example embodiment 800 relating to process 400, illustrated in FIG. 4. FIG. 8 illustrates transferring information from a selected memory bank 310 to other powered up memory banks 310, and powering down the selected memory bank 310.

As illustrated in FIG. 8, memory banks 310-1, 310-2, and 310-3 are powered up, and memory bank 310-N is powered down. Memory manager 330 determines that memory bank 310-1 is to be powered down, based on memory bank 310-1 having the best shutdown score. Based on the determination, memory manager 330 transfers information, stored by memory bank 310-1, to other powered up memory banks, such as memory banks 310-2 and 310-3, as indicated by reference number 810. In some embodiments, memory manager 330 powers down memory bank 310-1 after the information has been transferred, as indicated by reference number 820. Alternatively, memory manager 330 may power down memory bank 310-1 without transferring the information stored by memory bank 310-1 (e.g., if the information stored by memory bank 310-1 has not been used for an amount of time satisfying a threshold).

The information shown in FIG. 8, such as the quantity of powered up and/or powered down memory banks 310, is provided for explanatory purposes. In practice, memory manager 330 may use additional information, less information, different information, and/or differently arranged information than illustrated in FIG. 8.

Embodiments described herein may assist a CPU and/or another processing unit (e.g., a GPU, an APU, etc.) in determining one or more memory banks to power down based on resulting system performance and power consumption, which may be measured by metrics and incorporated into a score that may be used in making the determination.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term “component” is intended to be broadly construed as hardware, firmware, or a combination of hardware and software.

Some embodiments are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

It will be apparent that systems and/or methods, as described herein, may be implemented in many different forms of software, firmware, and hardware in the embodiments illustrated in the figures. The actual software code or specialized control hardware used to implement these systems and/or methods is not limiting of the embodiments. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by a processor, an indication that a memory bank is to be powered down;
determining, by the processor and based on receiving the indication, a plurality of shutdown scores corresponding to a plurality of powered up memory banks, each shutdown score, of the plurality of shutdown scores, being based on a shutdown metric associated with powering down a powered up memory bank, of the plurality of powered up memory banks;
powering down, by the processor, a selected memory bank, of the plurality of powered up memory banks, based on the plurality of shutdown scores.

2. The method of claim 1, where receiving the indication is based on at least one of:
receiving an indication of a change to a power state of a component that uses the powered up memory banks;
receiving an indication of a change to an operating voltage of a component that uses the powered up memory banks;
receiving an indication of a change to a memory footprint of a component that uses the powered up memory banks; or
determining that the shutdown metric satisfies a threshold.

3. The method of claim 1, where the shutdown metric comprises at least one of:
a quantity of blocks, in a particular memory bank of the plurality of powered up memory banks, that store dirty data;
a quantity of blocks, in the particular memory bank, that store non-dirty data;
a quantity of blocks, in the particular memory bank, that store non-native data;
a quantity of blocks, in the particular memory bank, that store native data;
a quantity of blocks, in the particular memory bank, that store dirty data predicted to be written to main memory;
a quantity of blocks, in the particular memory bank, that are unused;
a quantity of blocks, in the particular memory bank, that are used;
a quantity of blocks, in the particular memory bank, predicted to be unused;
a quantity of blocks, in the particular memory bank, predicted to be used;
a quantity of blocks, in the particular memory bank, that store shared information;
a quantity of blocks, in the particular memory bank, that store non-shared information;
a quantity of blocks, in the particular memory bank, that store exclusive information;
a quantity of blocks, in the particular memory bank, that store non-exclusive information;
a quantity of blocks, in the particular memory bank, that store an instruction or read-only information;
a quantity of blocks, in the particular memory bank, that store a non-instruction or non-read-only information;
a quantity of blocks, in the particular memory bank, accessed by central processing unit (CPU) requests; or
a quantity of blocks, in the particular memory bank, accessed by non-CPU requests.

4. The method of claim 3, where the quantity of blocks comprises an approximate quantity of blocks calculated by flagging a first block and a second block that meet a particular criteria, and where the method further comprises:
determining the quantity of blocks between the first block and the second block.

5. The method of claim 1, where the shutdown metric comprises at least one of:
an amount of time required to power down a particular memory bank of the plurality of powered up memory banks;
an amount of time that a block, in the particular memory bank, has been unused;
an amount of time that a block, in the particular memory bank, has been used;
a quantity of error correction code (ECC) errors reported by the particular memory bank;
an amount of energy or power consumed by the particular memory bank;
an amount of voltage required to operate the particular memory bank;
an access latency of the particular memory bank;
a quantity of accesses to the particular memory bank; or
a distance between the particular memory bank and another component.

6. The method of claim 1, where each of the plurality of shutdown scores is based on a weighted combination of shutdown metrics.

7. The method of claim 1, where each of the plurality of shutdown scores is based on a difference between a value of the shutdown metric measured before powering down the powered up memory bank, and an estimated value of the shutdown metric after powering down the powered up memory bank

8. A device, comprising:
one or more processors to:
receive an indication that a memory bank is to be powered down;
determine, based on receiving the indication, a plurality of shutdown scores corresponding to a plurality of powered up memory banks, each shutdown score, of the plurality of shutdown scores, being based on a shutdown metric associated with powering down a powered up memory bank, of the plurality of powered up memory banks;
power down a selected memory bank, of the plurality of powered up memory banks, based on the plurality of shutdown scores.

9. The device of claim 8, where the one or more processors, when receiving the indication, are further to at least one of:
receive an indication of a change to a power state of a component that uses the powered up memory banks;
receive an indication of a change to an operating voltage of a component that uses the powered up memory banks;
receive an indication of a change to a memory footprint of a component that uses the powered up memory banks; or
determine that the shutdown metric satisfies a threshold.

10. The device of claim 8, where the shutdown metric comprises at least one of:
a quantity of blocks, in a particular memory bank of the plurality of powered up memory banks, that store dirty data;
a quantity of blocks, in the particular memory bank, that store non-dirty data;
a quantity of blocks, in the particular memory bank, that store non-native data;
a quantity of blocks, in the particular memory bank, that store native data;
a quantity of blocks, in the particular memory bank, that store dirty data predicted to be written to main memory;
a quantity of blocks, in the particular memory bank, that are unused;
a quantity of blocks, in the particular memory bank, that are used;
a quantity of blocks, in the particular memory bank, predicted to be unused;
a quantity of blocks, in the particular memory bank, predicted to be used;
a quantity of blocks, in the particular memory bank, that store shared information;
a quantity of blocks, in the particular memory bank, that store non-shared information;
a quantity of blocks, in the particular memory bank, that store exclusive information;
a quantity of blocks, in the particular memory bank, that store non-exclusive information;
a quantity of blocks, in the particular memory bank, that store an instruction or read-only information;
a quantity of blocks, in the particular memory bank, that store a non-instruction or non-read-only information;
a quantity of blocks, in the particular memory bank, accessed by central processing unit (CPU) requests; or
a quantity of blocks, in the particular memory bank, accessed by non-CPU requests.

11. The device of claim 10, where the quantity of blocks comprises an approximate quantity of blocks calculated by flagging a first block and a second block that meet a particular criteria, and where the one or more processors are further to:
determine the quantity of blocks between the first block and the second block.

12. The device of claim 8, where the shutdown metric comprises at least one of:
an amount of time required to power down a particular memory bank of the plurality of powered up memory banks;
an amount of time that a block, in the particular memory bank, has been unused;
an amount of time that a block, in the particular memory bank, has been used;
a quantity of error correction code (ECC) errors reported by the particular memory bank;
an amount of energy or power consumed by the particular memory bank;
an amount of voltage required to operate the particular memory bank;
an access latency of the particular memory bank;
a quantity of accesses to the particular memory bank; or
a distance between the particular memory bank and another component.

13. The device of claim 8, where each of the plurality of shutdown scores is based on a weighted combination of shutdown metrics.

14. The device of claim 8, where each of the plurality of shutdown scores is based on a difference between a value of the shutdown metric measured before powering down the powered up memory bank, and an estimated value of the shutdown metric after powering down the powered up memory bank

15. A computer-readable medium storing instructions, the instructions comprising:
one or more instructions that, when executed by a processor, cause the processor to:
receive an indication that a memory bank is to be powered down;
determine, based on receiving the indication, a plurality of shutdown scores corresponding to a plurality of powered up memory banks, each shutdown score, of the plurality of shutdown scores, being based on a shutdown metric associated with powering down a powered up memory bank, of the plurality of powered up memory banks;
power down a selected memory bank, of the plurality of powered up memory banks, based on the plurality of shutdown scores.

16. The computer-readable medium of claim 15, where the one or more instructions, that cause the processor to receive the indication, further cause the processor to at least one of:
receive an indication of a change to a power state of a component that uses the powered up memory banks;
receive an indication of a change to an operating voltage of a component that uses the powered up memory banks;
receive an indication of a change to a memory footprint of a component that uses the powered up memory banks; or
determine that the shutdown metric satisfies a threshold.

17. The computer-readable medium of claim 15, where the shutdown metric comprises at least one of:
a quantity of blocks, in a particular memory bank of the plurality of powered up memory banks, that store dirty data;
a quantity of blocks, in the particular memory bank, that store non-dirty data;
a quantity of blocks, in the particular memory bank, that store non-native data;
a quantity of blocks, in the particular memory bank, that store native data;
a quantity of blocks, in the particular memory bank, that store dirty data predicted to be written to main memory;
a quantity of blocks, in the particular memory bank, that are unused;
a quantity of blocks, in the particular memory bank, that are used;
a quantity of blocks, in the particular memory bank, predicted to be unused;
a quantity of blocks, in the particular memory bank, predicted to be used;
a quantity of blocks, in the particular memory bank, that store shared information;
a quantity of blocks, in the particular memory bank, that store non-shared information;
a quantity of blocks, in the particular memory bank, that store exclusive information;
a quantity of blocks, in the particular memory bank, that store non-exclusive information;
a quantity of blocks, in the particular memory bank, that store an instruction or read-only information;
a quantity of blocks, in the particular memory bank, that store a non-instruction or non-read-only information;
a quantity of blocks, in the particular memory bank, accessed by central processing unit (CPU) requests; or
a quantity of blocks, in the particular memory bank, accessed by non-CPU requests.

18. The computer-readable medium of claim 15, where the shutdown metric comprises at least one of:
an amount of time required to power down a particular memory bank of the plurality of powered up memory banks;
an amount of time that a block, in the particular memory bank, has been unused;
an amount of time that a block, in the particular memory bank, has been used;
a quantity of error correction code (ECC) errors reported by the particular memory bank;
an amount of energy or power consumed by the particular memory bank;
an amount of voltage required to operate the particular memory bank;
an access latency of the particular memory bank;
a quantity of accesses to the particular memory bank; or
a distance between the particular memory bank and another component.

19. The computer-readable medium of claim 15, where each of the plurality of shutdown scores is based on a weighted combination of shutdown metrics.

20. The computer-readable medium of claim 15, where each of the plurality of shutdown scores is based on a difference between a value of the shutdown metric measured before powering down the powered up memory bank, and an estimated value of the shutdown metric after powering down the powered up memory bank.
